(19) United States
(12) Patent Application Publication
(10) Pub. No.: US 2011/0071765 A1
(43) Pub. Date: Mar. 24, 2011

(54) Device and Method for Alleviating Postprandial Hyperglycemia

(76) Inventors: Ofer Yodfat, Modi'in (IL); Gali Shapira, Haifa (IL); Iddo M. Gescheit, Tel Aviv (IL)

(21) Appl. No.: 12/993,038

(22) PCT Filed: May 14, 2009
(86) PCT No.: PCT/IL2009/000485

§ 371 Date: Nov. 16, 2010

Related U.S. Application Data
(60) Provisional application No. 61/053,930, filed on May 16, 2008.

(51) Int. Cl. G06F 19/00

(52) U.S. Cl. 702/19

(57) ABSTRACT

Embodiments of the present disclosure are directed to methods, systems and devices for alleviating postprandial hyperglycemia, as well as to methods and devices for sustained medical infusion of fluids, using, for example, skin securable insulin dispensing systems/devices.

### RELATED APPLICATION

The present application claims priority to U.S. Provisional Patent Application No. 61/053,930, filed May 16, 2008, the entire disclosure of which is herein incorporated by reference.

### FIELD

Various embodiments described herein relate generally to the field of medical devices. In particular, some embodiments relate to methods, systems and devices for alleviating postprandial hyperglycemia, as well as to methods and devices for sustained medical infusion of fluids, using, for example, skin securable insulin dispensing systems/devices.

### BACKGROUND

Diabetes mellitus is a disease of major global importance, increasing in frequency at almost epidemic rates, such that the worldwide prevalence in 2006 is 170 million people and predicted to at least double over the next 10-15 years. Diabetes is characterized by a chronically raised blood glucose concentration (hyperglycemia), due to a relative or absolute lack of the pancreatic hormone, insulin. Within the healthy pancreas, beta cells, located in the islets of Langerhans, continuously produce and secrete insulin according to the blood glucose levels, maintaining near constant glucose levels in the body.

Much of the burden of the disease to the user and to health care resources is due to the long-term tissue complications, which affect both small blood vessels (microangiopathy, causing eye, kidney and nerve damage) and large blood vessels (causing accelerated atherosclerosis, with increased rates of coronary heart disease, peripheral vascular disease and stroke). The Diabetes Control and Complications Trial (DCCT) demonstrated that development and progression of the chronic complications of diabetes are greatly related to the degree of altered glycemia as quantified by determinations of glycohemoglobin (HbA1c). [DCCT Trial, N Engl J Med 1993; 329: 977-986, UKPDS Trial, Lancet 1998; 352: 837-853. BMJ 1998; 317, (7160): 703-13 and the EDIC Trial, N Engl J Med 2005; 353, (25): 2643-53]. thus, maintaining normoglycemia by frequent glucose measurements and adjustment of insulin delivery accordingly is of utmost importance.

Frequent insulin administration can be done by multiple daily injections (MDI) with a syringe or by continuous subcutaneous insulin injection (CSII) carried out by insulin pumps. In recent years, ambulatory portable insulin infusion pumps have emerged as a superior alternative to multiple daily injections of insulin. These pumps can deliver insulin at a continuous basal rate as well as in bolus volumes. Generally, they were developed to liberate patients from repeated self-administered injections, and to allow greater flexibility in dose administration.

Several ambulatory insulin infusion devices are currently available on the market. The first generation of such devices employs disposable a syringe-type reservoir and tubes. These devices have been described in U.S. Pat. Nos. 3,771,694, 4,657,486, and 4,498,843. The main drawbacks of these devices are their large size and weight, caused by their spatial configuration and the relatively large driving mechanism associated with the syringe and the piston. These relatively bulky devices have to be carried in a patient's pocket or be attached to a belt. Consequently, the fluid delivery tube becomes long, e.g., longer than 40 cm, to enable needle insertion in remote locations of the body. These uncomfortable, bulky devices with a long tube are disfavored by many insulin users because they disturb regular activities, such as sleeping and swimming. In addition, the long delivery tube is not suitable for use with some optional remote insertion sites such as the buttocks and the extremities.

To avoid the shortcomings associated with the necessity of using long delivery tube, a new concept was proposed resulting in second generation devices. Devices based on the second generation concept included a housing having a bottom surface adapted for contact with the patient's skin, a reservoir disposed within the housing, and an injection needle adapted for communication with the reservoir. These skin adherable devices could be disposed of every 2-3 days, as is the case with current pump infusion sets. This devices conforming to the second generation paradigm were described, for example, by Schneider in U.S. Pat. No. 4,498,843, Burton in U.S. Pat. No. 5,957,895, Connelly, in U.S. Pat. No. 6,589,229, and by Flaherty in U.S. Pat. No. 6,740,059. Other configurations of skin adherable pumps are disclosed in U.S. Pat. Nos. 6,723,072 and 6,485,461. In these patents the pump is a single piece adherable to the patient skin for the entire usage duration. The needle emerges from the bottom surface of the device and is fixed to the device housing. The disadvantage of these second-generation skin adherable devices lies in the fact that they are expensive, bulky and heavy.

In an effort to address the shortcomings of the 2^{nd} generations devices, a 3rd generation skin adherable pump was proposed as described in co-owned, co-pending U.S. publication No. 2007-0106218, the disclosure of which is hereby incorporated by reference in its entirety. This pump is configured as a miniature portable programmable dispensing patch that has no tubing and that can be attached to a patient's skin. It can be composed of two parts, a disposable part that contains a reservoir and an outlet port and a reusable part that contains the electronic parts and a driving mechanism. This device may also comprise a remote control unit that can allow data acquisition, programming, and user inputs. The device may also comprise a glucometer that can monitor body glucose concentration levels. The glucometer may be located in the remote control unit of the device or in the reusable part of the dispensing patch unit. The device may also comprise a continuous glucose monitor (CGM) that can continuously monitor body glucose concentration levels (i.e. frequent discrete measurements, e.g. every 3-5 minutes). The CGM may be an independent unit of the device or it may be located in the dispensing patch unit of the device. The CGM comprises a cannula located in the subcutaneous tissue and the glucose is measured in the interstitial fluid (ISF). The CGM may comprise an independent cannula or it may share the insulin dispensing cannula of the device, as described in co-owned, co-pending U.S. patent applications Ser. Nos. 11/706,606 and 11/963,481, assigned to Medingo, the disclosures of which are hereby incorporated by reference in their entireties.

Such CGM containing devices can be capable of operating in one or more of a closed loop, and open loop, or a semi-open loop mode. In a closed loop mode, an analyte concentration is sensed by a sensor and determined by a processor and the processor commands a dispensing apparatus to dispense one or more therapeutic fluids to the human body based on the determined concentration. In an open loop mode, the sensing and dispensing functions are not linked. A device in this mode could indicate a value for the determined analyte concentration, but no feedback control is exercised over the rate of dispensing. A user interface or other means by which a user can communicate commands to the device can allow the user to dispense the therapeutic fluid. In the semi-closed mode, the sensing occurs as noted above for the closed loop mode. However, the device can wait for confirmation or alternatively it can request such confirmation, possibly via some user interface, from a user before dispensing the therapeutic . fluid in the amounts that might be needed based on the determined analyte concentration.

As mentioned, insulin pumps have been available and can deliver rapid acting insulin 24 hours a day through a catheter placed under the skin (subcutaneously). The total daily insulin dose can be divided into basal and bolus doses. Basal insulin can be delivered continuously over 24 hours, and keeps the blood glucose concentration levels (namely, blood glucose levels) in normal desirable range between meals and overnight. Diurnal basal rates can be pre-programmed or manually changed according to various daily activities.

Insulin bolus doses can be delivered immediately before or after meals to counteract carbohydrates loads or during episodes of high blood glucose levels. The insulin used in insulin pumps can be rapid acting (e.g. aspart, lispro, glulisine) and can be given subcutaneously. Peak serum levels of subcutaneously administered rapid acting insulin can be seen 30 to 90 minutes after dosing. The lag period can be substantially longer than in healthy individuals, where the insulin is secreted directly into the portal system, avoiding absorption period from the subcutaneous tissue. In addition, insulin in healthy individuals may partly be secreted before a meal as an endogenous response mediated by different peptides and hormones such as ghrelin.

The after-meal (postprandial) peak can be defined as the net rise of blood glucose that occurs from before eating to the highest point after eating. The ADA recommends that the ideal glucose concentration level should be less than 180 mg/dl one to two hours after the beginning of the food intake (also may be referred to as caloric intake).

Increasing evidence suggests that the postprandial hyperglycemia can be a contributing factor to high levels of HbA1c and development of diabetes short and long term complications. The association of postprandial “hyperglycemic spikes” with the onset of late cardiovascular complications has recently received much attention. It has been shown that postprandial hyperglycemia can be a direct and independent risk factor for cardiovascular disease (CVD). The mechanisms through which acute hyperglycemia exerts its effects may be identified in the production of free radicals. Correcting the postprandial hyperglycemia may form part of the strategy for the prevention and management of CVDs in diabetes (Diabetes 2005; 54:1-7.)

Short term problems attributed to postprandial hyperglycemia can also be evident. For example, tiredness, concentration difficulties, decreased desire to move, mood shifts, and enhanced hunger—can all be consequences of postprandial hyperglycemia. It may be concluded that prevention of postprandial hyperglycemia is of utmost importance.

Currently available insulin pumps have no effective means to cope with postprandial glucose peak. Bolus administration immediately before meals cannot avoid the postprandial glucose peak because insulin effect usually lags behind glucose absorption and consequently blood glucose rises and peaks, as can be seen in FIG. 1. This figure shows curves of blood glucose and insulin levels (y axis) over time (x axis) after a meal intake and an insulin bolus, and the lag period between glucose and insulin blood levels peaks. Blood insulin levels usually lag behind blood glucose levels when insulin is administered at the time of oral glucose intake. This phenomenon consequently leads to blood glucose rises and peaks, as can be seen in the figure.

### SUMMARY

Techniques, systems and devices are provided for alleviating postprandial hyperglycemia (“PPH”). In some embodiments, a device and a method for alleviating postprandial hyperglycemia are provided. For example, in one variation; a device for alleviating postprandial hyperglycemia can comprise a first user interface for configuring an food intake time (e.g., a time that the user expects or estimates that food/calories will be ingested, which may also be referred to as “expected food intake”) and a food intake type, where the food intake type corresponds to at least one of an amount of carbohydrates, the glycemic index of such carbohydrates, fat content, and meal size. The food intake type corresponds to the type of food that a user expects or estimates he will be consuming (may be referred to as “expected food intake type”). A bolus selector may be provided, adopted for selecting a total bolus dose of a drug corresponding to at least one of the food intake time and the food intake type and a glucose concentration level of a user. In such embodiments, the bolus selector may further be adopted for dividing the total bolus dose into a first phase bolus dose scheduled for delivery using, for example, a first phase bolus delivery rate at a first phase bolus delivery time, and a second phase bolus dose, for example, scheduled for delivery using a second phase bolus delivery rate at a second phase bolus delivery time.

In some embodiments, the methods, systems and/or devices for alleviating postprandial hyperglycemia may include determining the total bolus dose, which may be accomplished using a processor present on any one or more components of the system and/or device, and may be carried out using software.

In some embodiments, the systems, methods and/or device for alleviating postprandial hyperglycemia, the first phase bolus dose may correspond to a pre-meal delivery dose according to the first phase bolus delivery rate at the first phase bolus delivery time, and the second phase bolus dose may comprise one of one or more consecutive phases of bolus doses scheduled for delivery according to programmed bolus delivery rates and corresponding bolus delivery times.

In some embodiments, a device (e.g., as described above) for alleviating postprandial hyperglycemia can further comprise a second user interface for adjusting at least one of the second phase bolus dose, the second phase bolus delivery rate and the second phase bolus delivery time.

In some embodiments, the first phase bolus delivery time can be, for example, 10-90 minutes before the food intake time. In some embodiments, the first phase bolus dose, the first phase bolus delivery time, the second phase bolus dose and the second phase bolus delivery time can be selected based on a daily bolus plan, for example. The device for alleviating postprandial hyperglycemia can further comprise a history module adopted for maintaining a history of the first phase bolus dose, the first phase bolus delivery time, the second phase bolus dose and the second phase bolus delivery time, for example. Moreover, the daily bolus plan may be derived from the maintained history of bolus doses and bolus delivery times. In some embodiments , the first phase bolus dose can be about 10-90%, for example, of the total bolus dose. The first phase bolus dose can be selected corresponding to the glycemic index of the food intake. The first phase bolus delivery rate can also correspond to the glycemic index of the food intake.

In some embodiments, the device for alleviating postprandial hyperglycemia can further comprise a notification module for notifying (i.e., reminding, the terms “notifying” and “reminding”, as well as variations thereof, are used interchangeably throughout the present disclosure) the user to consume the food intake prior to the food intake time.

In some embodiments, the sum of the first phase bolus dose and the second phase bolus dose can be equal the total bolus dose.

The device for alleviating postprandial hyperglycemia can further comprise a notification module for reminding the user to administer any portion of the total bolus dose prior to the food intake time.

In some embodiments, the device can further comprise a sensing unit adopted for determining the glucose concentration level the user. For example, the sensing unit can include a glucometer. The sensing unit can also include a continuous glucose monitoring unit (CGM) to periodically measure the glucose concentration level of the user. The sensing unit can, in some embodiments, communicate with a dispensing unit in a semi-closed loop mode.

In some embodiments the notification module can notify the user using at least one of the visual, audible or vibrational signals. The notification module can notify the user, for example, using a remote control unit, a dispensing unit, a PDA, a laptop or a watch. In some embodiments, the notification module activates notification signals 10-120 minutes prior to the food intake time, for example. The notification module can also notify/remind the user to administer each bolus phase derived from the total bolus dose.

In some embodiments, the device for alleviating Postprandial hyperglycemia can use insulin and the notification/reminder time (i.e., for activation) can correspond to the insulin type. The reminder time can also correspond to the food intake time. In some embodiments, the reminder time can correspond to the food intake type. In some embodiments, the user can be notified/reminded to administer each scheduled bolus phase.

The device for alleviating postprandial hyperglycemia can further comprise a drug delivery module adopted for administering the first phase bolus dose using the first phase bolus delivery rate to the user; and, administering the second phase bolus dose using the second phase bolus delivery rate to the user.

In some embodiments, the device can further comprise a skin securable patch unit and/or a disposable part and a reusable part. The device can comprise a remote control unit. In some embodiments it can also comprise a skin securable cradle unit allowing disconnection and reconnection of the patch unit.

In one embodiment programming of the device can be carried out manually by operating buttons located on the dispensing patch unit. In one embodiment, the dispensing patch unit can be composed of two parts—a disposable part and a reusable part. The disposable part can contain reservoir, outlet port, and other relatively inexpensive components. The reusable part can contain electronics (PCB, processor, etc) driving mechanism and other relatively expensive components.

In one embodiment, a cradle unit can be provided which can be a relatively flat sheet that, for example, secures to the skin and allows patch disconnection and reconnection upon a patient's discretion. After attachment of the cradle unit to the skin, a cannula can be inserted into the subcutaneous compartment through a dedicated passageway in the cradle unit.

### BRIEF DESCRIPTION OF THE DRAWINGS

FIG. 1 illustrates exemplary curves of blood (plasma) glucose and insulin levels over time after a meal intake and an insulin bolus administration.

FIG. 2 illustrates one embodiment of an insulin infusion device/system which comprises an insulin dispensing unit and a remote control unit that contains a feature for PPH alleviation.

FIG. 3 is a diagram illustrating a typical pattern of insulin secretion in healthy individuals.

FIG. 4 is a flow chart representing an exemplary method for PPH alleviation, according to some embodiments of the present disclosure.

FIG. 5 is a flow chart representing an exemplary method for PPH alleviation, according to some embodiments of the present disclosure.

FIG. 6 is a flow chart representing another exemplary method for PPH alleviation, according to some embodiments of the present disclosure.

FIGS. 7a-h provide illustrations of a PPH alleviating feature user's interface, according to some embodiments of the present disclosure.

FIG. 8 provides an illustration of one example of a user interface for a PPH alleviating feature including a window for inputting a daily bolus plan, according to some embodiments of the present disclosure.

FIG. 9 provides an illustration of one example of a user's interface for a PPH alleviating feature including a window for confirming delivery of the first phase bolus, according to some embodiments of the present disclosure.

FIG. 10 provides an illustration of one example of a user's interface of a PPH alleviating feature including a window for reminding the user to consume the meal, according to some embodiments of the present disclosure.

FIG. 11 provides an illustration of one example of a user's interface for a PPH alleviating feature including a window for inputting current blood glucose levels, and carbohydrate load of the intake immediately before the meal, according to some embodiments of the present disclosure.

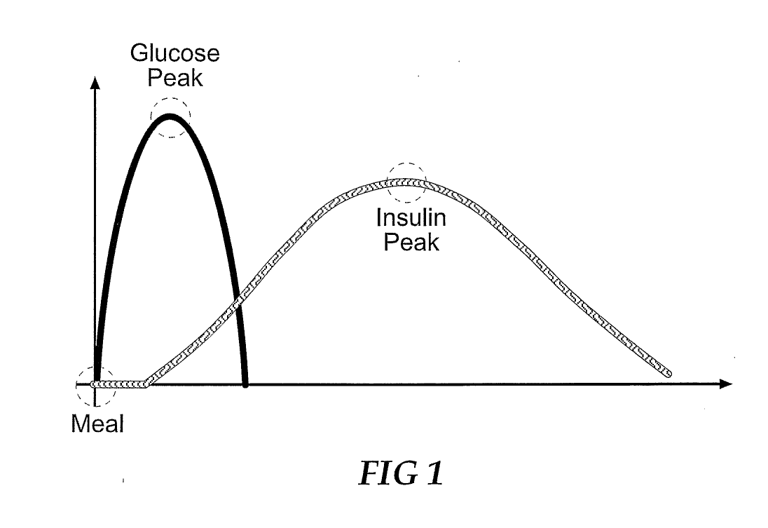

### DETAILED DESCRIPTION

Systems, devices and methods for alleviating postprandial hyperglycemia are provided. In some embodiments, a device for alleviating postprandial hyperglycemia can include a first user interface for configuring a food intake time and a food intake type. The food intake type can correspond to at least one of the amount of carbohydrates, glycemic index, fat content, and meal size. The device can further include a bolus selector adopted for selecting a total bolus dose of a drug corresponding to at least one of the food intake time and the food intake type and a glucose concentration level of a user. The bolus selector can be further adopted for dividing the total bolus dose into a first phase bolus dose scheduled for delivery using a first phase bolus delivery rate at a first phase bolus delivery time, and a second phase bolus dose, scheduled for delivery using a second phase bolus delivery rate at a second phase bolus delivery time (for example). In some embodiments, the total bolus dose may be divided into a single phase, two phases, three phases or more (for example).

In some embodiments, a method for alleviating postprandial hyperglycemia can comprise providing a first user interface for configuring a food intake time and a food intake type. The food intake type can corresponding to at least one of the amount of carbohydrates, glycemic index (e.g., of the carbohydrates), fat content, and meal size. Also, selecting a total bolus dose of a drug corresponding to at least one of the food intake time and the food intake type and a glucose concentration level of a user may be provided, as well as the ability to divide the total bolus dose into, for example, a first phase bolus dose scheduled for delivery using a first phase bolus delivery rate at a first phase bolus delivery time, and a second phase bolus dose, scheduled for delivery using a second phase bolus delivery rate at a second phase bolus delivery time, and any combination thereof.

In some embodiments, a method for alleviating PPH may be provided, which may be implemented via a device and/or system according to one or more of the disclosed embodiments. In some embodiments, the method for alleviating postprandial hyperglycemia can be based on biphasic bolus administration, emulating the physiological pancreatic β cell activity, for example. The total bolus dose can be divided, for example, into two additive sub-doses, and each sub-dose can be given as a separate bolus phase (i.e. first phase bolus and second phase bolus). According to some embodiments, the first phase bolus can be given about 10 to 90 minutes, for example, before the second phase bolus, which can be administered around the meal time (for example). According to some embodiments, the first phase bolus can be given at the fastest rate possible and the second bolus phase can be given at a slower rate that, for example, may be maintained for several hours. According to some embodiments, the rate of the first phase bolus can be determined according to the characteristics of the contemplated meal. For example, if a rapidly absorbed meal (high glycemic index) is planned, than both first and second phase boluses may be delivered at a fast rate. If a slowly absorbed meal (low glycemic index) is planned, than both first and second phase boluses may be delivered at a relatively slow rate. If a meal comprising slowly absorbed component (low glycemic index) and a rapidly absorbed component (high glycemic index) is planned, than the first phase bolus is delivered at a fast rate and the second phase bolus is delivered at a relatively slow rate, for example.

According to some embodiments, a percentage of the total dose given as a first sub-dose (i.e. first phase bolus) can be based on the glycemic index of the meal. For example, if the glycemic index of the contemplated meal is high, than a relatively higher percentage of the total bolus dose will be given in the first phase bolus. Similarly, if the glycemic index of the contemplated meal is low, then a relatively smaller percentage of the total bolus dose will be given in the first phase bolus.

According to some embodiments, the percentage of the total dose given as a first sub-dose can be based on the size of the total dose. For example, if a meal with a low carbohydrate load is contemplated and a small dose is required, the first phase bolus may be of a relatively high percentage of the total dose (e.g. about 50%), but if a meal with a high carbohydrate load is contemplated and a large dose is required, the first phase bolus may be of a relatively low percentage of the total dose (e.g. about 20%). This embodiment serves as a safety measure and allows the user to skip the meal without the risk of serious hypoglycemia.

According to some embodiments, the percentage of the total dose given as a first sub-dose can be based on the size of the total dose meant to cover the contemplated meal and the glycemic index of the contemplated meal.

According to some embodiments, after the administration of the first phase bolus, the user can be notified/reminded to eat the contemplated meal and administer the second phase bolus. In some embodiments, the user can “snooze” the notification/reminder by temporarily deactivating it. The “snooze” time period can be pre-configured. In some embodiments, the user can modify the “snooze” time of the reminder by adjusting the preferences. For example, if the “snooze” time is preconfigured to five minutes and, after receiving a first reminder to eat, the user decides to “snooze,” the notification will be disabled for five minutes and then, after 5 minutes enabled again.

In another example, a user can administer a bolus dose which is based on the meal intake time of 12 pm. At 11:55 am, the user will get a reminder to eat. If the user decides to “snooze” the reminder, the device will notify/remind the user again after five minutes, to make sure he eats. This can be iterative until the user turns the reminder off.

In some embodiments, a last day(s) boluses (time and dose) can be stored in the memory of the PPH alleviating feature. The average dosing times and average dose delivered during specific time intervals (e.g. average boluses, time and dose, administered in the last week between 6 to 10 a.m.) can be used to automatically administer the first phase bolus with or without user interface. This feature can be especially beneficial for users with routine daily intakes.

In some embodiments, the bolus doses and times of administration can be averaged from the values corresponding to the same time interval in the same basal profile. For example, only the boluses given between 6 to 10 a.m. in the last 7 “weekend” profiles will be averaged together. In one embodiment, the averaged bolus can be applied for the PPH alleviating feature only if the standard deviation is small. If a significant deviation is noted, the averaged bolus value is not applied.

In some embodiments, if the first phase bolus has already been administered and the user chooses to skip the planned meal, the user may cancel the second phase bolus and the extra insulin that has already been delivered in the first phase bolus can be compensated for by reduction of basal rate.

In some embodiments, if the first phase bolus has already been administered and the user chooses to consume a smaller meal than initially planned, the second phase bolus can be automatically adjusted according to the new carbohydrate load of the meal and according to the amount of insulin already delivered in the first phase bolus. If the first phase bolus was larger than needed to cover the smaller meal, the extra insulin that has already been delivered can be compensated for by reduction of basal rate.

According to some embodiments, the user with a daily routine can program a daily bolus plan. For example, the first phase boluses can be automatically delivered about 10-90 minutes prior to the meal time and the second phase boluses can be delivered after the user has been reminded to eat and a meal confirmation has been received. In some embodiments, the infusion device can comprise a memory that stores more than one daily bolus plan, for example a weekday plan and a weekend plan.

The timing of insulin boluses, according to some embodiments, has the potential to be effective in alleviation of postprandial hyperglycemia. A prolonged time gap between insulin bolus administration and eating allows insulin to be absorbed from the subcutaneous tissue and immediately counteract the meal glucose. This treatment mode, for example, requires the user to remember to administer the bolus long before the meal. In addition, had an early bolus been administered and the user decides to skip the meal or even to eat less than the planned amount, the user can end up with more insulin than necessary and consequent hazardous hypoglycemia.

In some embodiments, the device can provide a miniature skin securable patch that can continuously dispense insulin and monitor body glucose concentration levels and a method for administering a pre meal bolus at an optimal timing. If the level is higher than a predefined threshold (i.e. the insulin was not balanced by the carbohydrates ingested) the user can be notified by an alarm. In some embodiments, the “insulin overdose” notification can be forwarded to a remote recipient, such as a remote computer or a remote control unit.

In some embodiments, if excessive insulin has been administered to the user's body, the device can recommend the user to eat—i.e., consume a corresponding number of carbohydrates in order to stabilize his blood sugar/insulin. In some embodiments, a user can be advised to administer an “agonist” substance such as glucagon to regulate the activity of the excessive amount of administered insulin or the user can be advised to reduce the basal insulin rate.

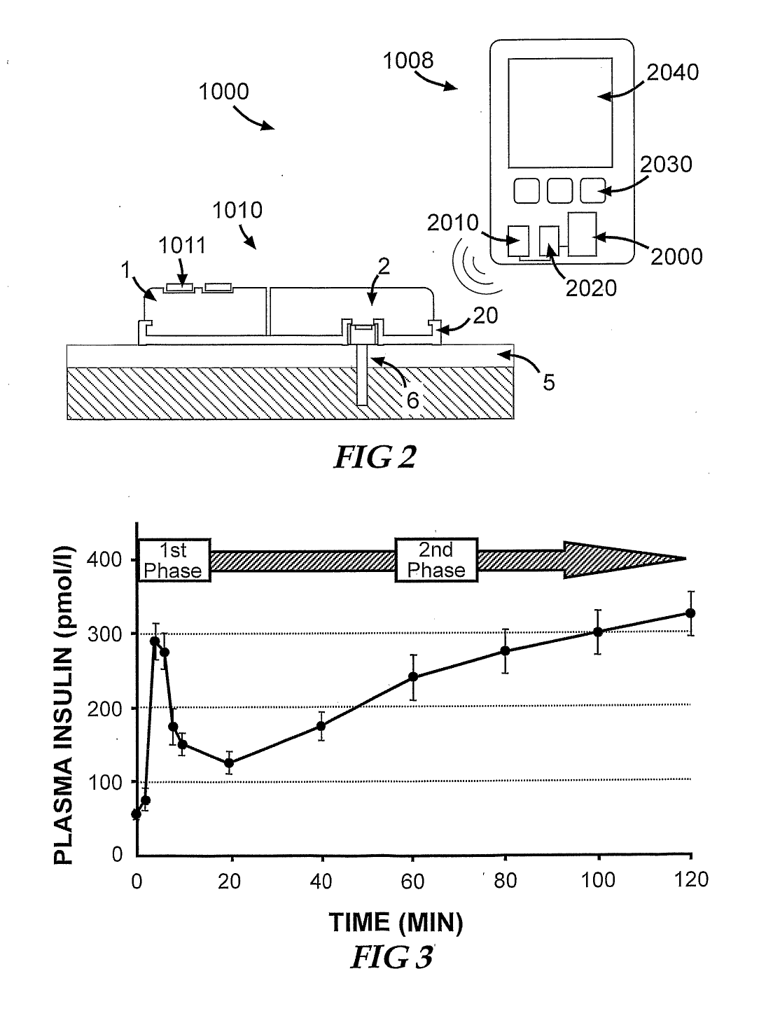

For example, FIG. 2 provides an example of the insulin infusion device/system (1000) which includes a dispensing patch unit (1010) adherable to the user's skin (5), and may further include a remote control unit (1008), which can communicate with the dispensing patch unit (1010), allowing programming, user inputs and data acquisition.

The dispensing patch unit (1010), also referred-to as “patch unit”, can be removable and connected to a cannula (6) that can penetrate the skin (5) to allow delivery of insulin to the patient (also referred to herein as “user” hereinafter). The patch unit (1010) can be attached to a dedicated cradle unit (20) that can be a structure which is adhered to the user's skin (5) and can allow connection/disconnection of the patch unit (1010). An exemplary embodiment of this arrangement is discussed in a co-owned, co-pending U.S. publication No. 20080215035 and International Patent Application No. PCT/IL2007/001578, the disclosures of which are incorporated by reference hereto in their entireties.

Manual inputs can be carried out by one or more buttons (1011) located on the dispensing patch unit (1010). In some embodiments, the dispensing patch unit (1010) can be composed of one housing or two housings comprising a reusable part (1) and a disposable part (2) as disclosed for example in co-owned, co-pending U.S. publication No. 20070106218 and International Patent Application No. PCT/IL2009/000388, the disclosures of which are incorporated by reference in their entireties.

In some embodiments, the remote control unit (1008) can include a PPH alleviating feature (2000), a processor (2010), a memory (2020), input means (2030) (e.g. buttons, switches, touch screen, voice command device), a display (2040) and/or other indication means, such as audible means (e.g. buzzer) and vibration means (e.g. vibrator) for notifying the user and communicating data to the user (e.g. alarms, alerts). The input means (2030) can also be provided for operating the PPH alleviating feature (2000) and for dispensing patch unit (1010) programming.

The PPH alleviating feature (2000) can provide insulin bolus timing based on a multi-phasic (e.g. biphasic) bolus administration plan wherein a first phase bolus is given about 20-90 minutes before the second phase bolus which can be administered around the meal time.

According to some embodiments, the PPH alleviating feature can be located in the reusable part of the dispensing patch unit or shared between the reusable part and the remote control unit, exclusively in the remote control unit, and in some embodiments, the disposable portion of the dispensing patch unit.

FIG. 3 illustrates one example of a biphasic pattern of insulin secretion in healthy individuals during a 2 hour hyperglycemic (7.9 mmol/L or 142 mg/dL) clamp. Distinct first phase (e.g., 0-10 min) and second phase (e.g., 20-120 min) insulin secretory responses are evident (Diabetologia 2001, (44), 929-945). Employing the PPII alleviating feature in conjunction with a patch unit, for example, delivering insulin to a subcutaneous compartment of a user accordingly, can maintain better glycemic control, for example, in the postprandial period, by emulating the physiological insulin secretion depicted in FIG. 3.

In some embodiments, the insulin administration can be related to the depicted biphasic insulin response with a time lag between insulin administration and a successive meal. In some embodiments, insulin administration can precede the meal in accordance with an insulin absorption model (e.g. the model proposed by Schichiri et al. in Artif. Organs 1998 (22) 32-42), in order to comply with the difference between subcutaneously injected insulin and endogenous insulin secreted into the portal system (for example).

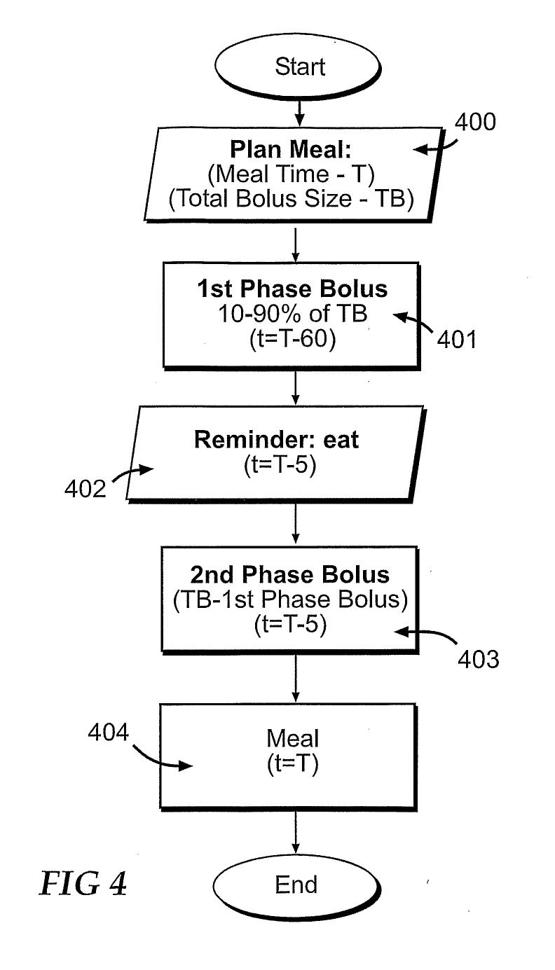

FIG. 4 illustrates a flow chart of an exemplary algorithm for implementing a PPH alleviating method according to some embodiments. Accordingly, at 400, the meal total bolus at least one of and preferably both of size (TB) and meal time (T) (e.g. start time of a meal) can be configured. In some embodiments, the total bolus size (TB) can be selected, for example, via a bolus selector, disclosed in co-owned, co-pending U.S. publication no. 20080234663 and International Patent Application Nos. PCT/IL2008/000380 and PCT/IL2009/000454, the disclosures of which are incorporated by reference in their entireties.

In some embodiments, each total bolus can be automatically divided/segmented, by the PPH alleviating feature, into two phases, for example. In some embodiments, the first phase bolus can comprise a range of about 10% to about 90% of the total bolus (TB). For example, the first phase can be administered between about 15 and about 60 minutes, and narrower ranges thereof (in some embodiments) before the approximate meal time (i.e. time of first phase bolus (t) is T-60), as illustrated at 401. In some embodiments, the amount of the first phase bolus can be selected based on the glycemic index (GI) of the meal (e.g. the higher the GI, the larger the amount of the first bolus dose).

For example, before the user consumes the planned meal time (e.g. 5 minutes before the start of the meal (t)), a reminder 402 to the user can be presented, to consume the meal. At this time before the planned meal (e.g. 5 minutes before the meal) and/or after the user has been reminded to eat, the second phase bolus can be delivered, as illustrated at 403. In some embodiments, the amount of the second phase bolus can be equal to the total bolus (TB) configured at 400 minus the size of the first phase bolus delivered at 401. At 404, the planned meal is consumed.

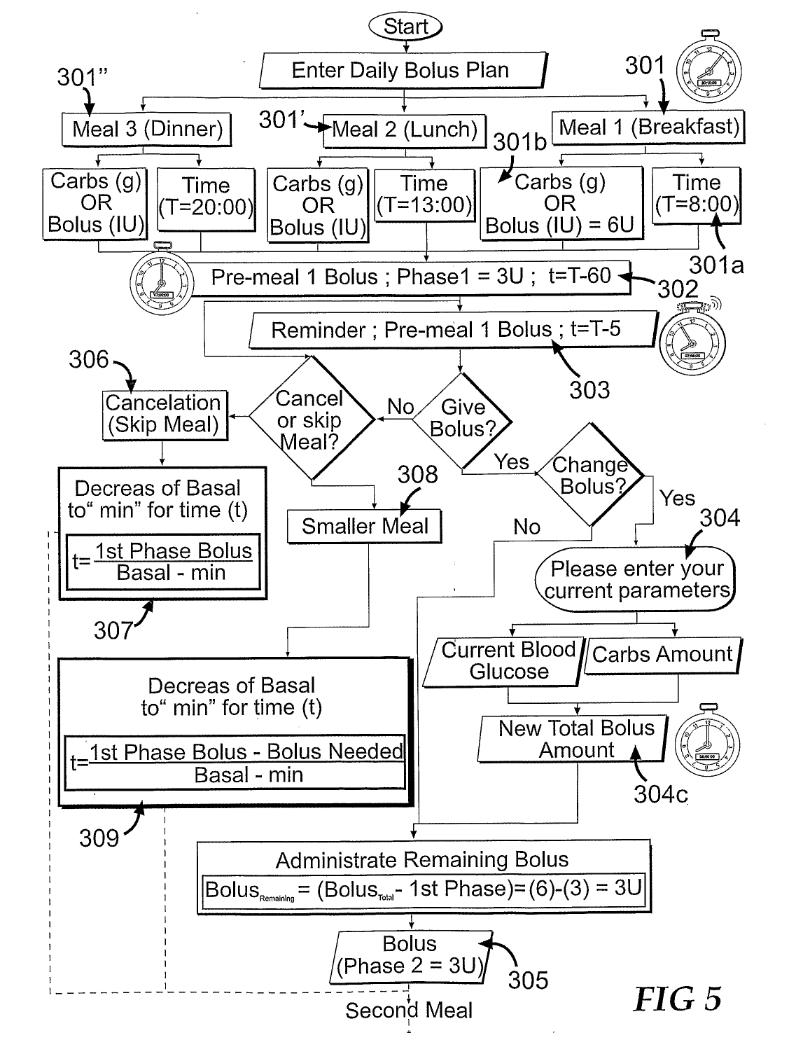

FIG. 5 is a flow chart representing one example of an exemplary algorithm implementing the PPH alleviating method according to some embodiments. The first step (301, 301′, 301″) can be setting of a daily bolus plan which may comprise input of the number of meals, their approximate total bolus sizes and approximate times/schedules (for example). In the given example, the first meal of the day (Meal 1) is planned at 8:00 am (301a) and may require a bolus of 6U (301b) to balance the meal content to be consumed.

Each total bolus can be automatically divided/segmented by the PPH alleviating feature into multiple (e.g. two) phases. For example, the first phase bolus of the meal (also referred-to as “pre-meal 1 bolus”), can range from about 10% to about 90% of the total bolus (and ranges therebetween), and can be administered about 20 to about 90 minutes before the approximate meal time T (302)(and ranges therebetween). In the given example, taking care of Meal 1, 50% of the planned bolus, i.e., 3U, can be administered as the first phase bolus, 60 minutes before the planned meal, i.e., at 7:00 am.

At about 5 to about 20 minutes before the planned meal time, the user can be reminded to consume the meal (303). In the given example, the user is reminded to eat 5 minutes before the planned meal (t=T-5), i.e. at 7:55 am. At that time, the user may change the total bolus amount (304) in accordance with the contemplated meal, and the size of the second phase bolus can be further selected accordingly, i.e. the size of the second phase bolus, to be delivered immediately before or after the meal (305), can be equal to the new total bolus size minus the size of the first phase bolus. The manner of selection of the total bolus size as given at (301) can also be applied for the final selection of the second phase bolus.

In some embodiments, the total bolus size at (304) can be selected from a bolus selector, based on the carbohydrate load of the meal and the current blood glucose level as described for example in co-owned, co-pending U.S. publication No. 2008-0234663 and International Patent Application No. PCT/IL2008/000380, the disclosures of which are incorporated by reference hereto in their entireties. In some embodiments, the total bolus size in step (304) can also be selected from a bolus selector as described in co-owned, co-pending International Patent Application No. PCT/IL2009/000454, the disclosure of which is incorporated by reference hereto in its entirety. In some embodiments, the bolus dose can be calculated and selected as the total bolus value.

In the given example, the approximation of the total bolus size (6 U), as given at step 301b is applied for approximation of the second phase bolus, so that the second phase bolus is 3 U which is equivalent to the 6 U minus the 3 U given at first phase bolus.

Had the user, for example, decided to eat for the first meal an additional slice of bread which can be balanced by 0.5 U of insulin, a new total bolus amount of 6.5 U (6+0.5) should have been inputted at step 304c. The second phase bolus would than have been 3.5 U, which is equal to 6.5 U (new total bolus minus 3 U dose of the first phase bolus). Iddo—please confirm.

If the first phase bolus (also referred to as “Phase1 Bolus” and “Phase1”) has already been administered and the user chooses to skip the planned meal, as depicted in step (306), then the user can cancel the second phase bolus. The insulin that has already been delivered in the first phase bolus can be compensated for by reduction of basal rate (basal) to minimum (i.e. minimum basal rate that can be delivered by the device (MIN), e.g. 0.1 U/h) for a period of time (T) according to the equation depicted in step (307): T=Phase1Bolus/(Basal−MIN). For example, below please find a scenario including the following set of parameters(not shown in FIG. 5):

Current basal rate→1.6 U/h;

Minimal pump basal rate→MIN=0.1 U/h;

Daily planned meal bolus→6 U;

A first phase bolus of 3 U was administered 1 hour before the planned meal;

User wants to skip the meal;

The insulin that has already been delivered in the first phase bolus can be compensated for by reducing the basal rate (basal) to minimum (0.1 U/h) for 2 hours according to the following equation:

T=Phase1Bolus/(basal−MIN)=3/(1.6−0.1)=2 hours.

If the first phase bolus (Phase1Bolus) has already been administered and the user chooses to consume a smaller meal than initially planned as depicted in step (308), and the first phase bolus was larger than needed to cover the smaller meal (BolusNeeded is the bolus dose required to balance the smaller meal than initially planned), the additional insulin that has already been delivered can be compensated for by reduction of basal rate (basal) to minimum (MIN) for a certain time period (T) according to the equation (309): T=(Phase1Bolus−BolusNeeded)/(basal−MIN). For example, below please find a scenario including the set of the following parameters (not shown in FIG. 5):

Current basal rate→1.6 U/h

Minimal pump basal rate→0.1 U/h

Daily planned meal bolus→6 U

A first phase bolus of 3 U was administered 1 hour before the planned meal

If a user wants to eat a smaller meal than initially planned—that meal may be balanced merely by 2 U of insulin (as opposed to the initially planned meal balanced by 6 U). Iddo—please confirm.

Since the insulin dose delivered for the first phase bolus (3 U) is larger than the dose (2 U) required to cover the smaller meal, the insulin that has already been delivered in the first phase bolus can be compensated for by reducing basal rate (basal) to minimum (0.1 U/h) for 40 minutes according to the following equation (for example):

T=(Phase1Bolus−BolusNeeded)/(basal−MIN)=(3−2)/(1.6−0.1)=0.66 hour=40 minutes.

In some embodiments, the user can halt a currently administered bolus phase. For example, if the first phase bolus administration has begun and the user changes his or her mind about the size, time or type of the contemplated meal, the user can halt the administration of the bolus. In that case, the PPH alleviating feature can help the user, as described above, to select another first bolus dose, and/or delivery time and/or or bolus delivery rate. In some embodiments, the PPH alleviating feature can also provide a recommendation or suggestion to the user to consume an amount of carbohydrate in order to balance the previously administered insulin.

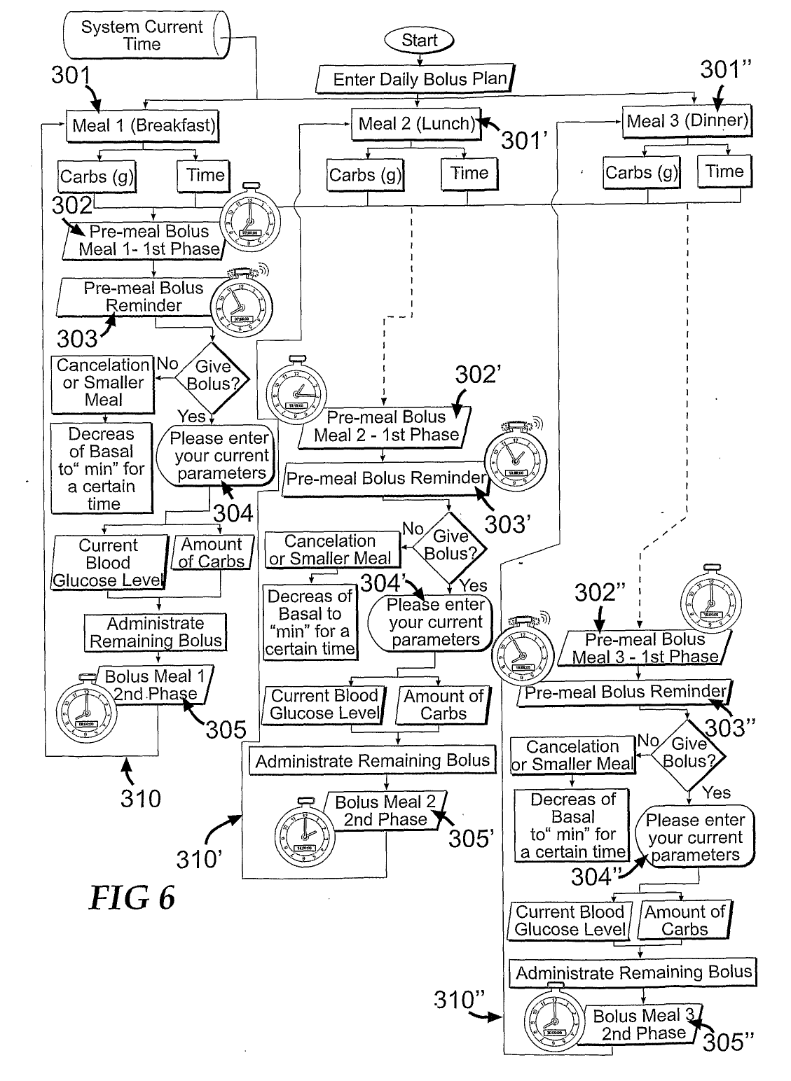

FIG. 6 is a flow chart representing one example of a more complex algorithm implementing a PPH alleviating method according to some embodiments. For example, step (310, 310′, 310″) can be an optional function of the PPH alleviating feature. This function can calculate the average bolus dose and meal time during a selected time interval in the last few days, for example, and present this information to the user, e.g. on a screen/display. This information can be further used by the PPH alleviating feature. For example, the day can be divided into five temporally intervals (e.g. 6:00-10:00, 10:00-14:00, 14:00-18:00. 18:00-22:00, 22:00-6:00) and the average of the total amount of insulin delivered and the time of delivery during the corresponding a time interval (in the last several days for example) can be the featured value (310,310′, 310″). In some embodiments, this value can be used as an recommendation for programming a daily bolus plan.

For example, if the user administered the following second phase bolus (e.g. 5 minutes before the meal) during the past 3 days: 2 U at 6:00 pm, 2.5 U at 6:30 pm, 1.5 U at 5:30 pm, then the featured value in step 310″ is 6:00 pm as the average time and 2 U as the average dose (i.e. (2+2.5+1.5)/3=2). That is, when the user is asked to set a daily bolus plan, which can include information about the meals (i.e. the approximate total bolus size and the approximate time), then a bolus of 2 U can automatically be scheduled for delivery at 6:00 pm (for example). The user may then confirm the automatically set meal information. Alternatively, the user may change the automatic settings and/or recommendation and/or suggestion. Such a suggested feature value can be especially convenient for users with a daily routine.

The defined time interval can also be selected from a basal profile. This profile can be customized for daily basal insulin requirements, e.g., only the boluses given between 6 am to 10 am in the last 7 “weekend” profiles (a “weekend” profiles may be defined as a profile administered during the weekend) can be averaged together, for example. The data regarding the time and the dosages of the previous boluses can also be stored in a memory, for example in memory (2020), as illustrated in FIG. 2, and can be further displayed (e.g. on a screen) periodically or at the patient's discretion.

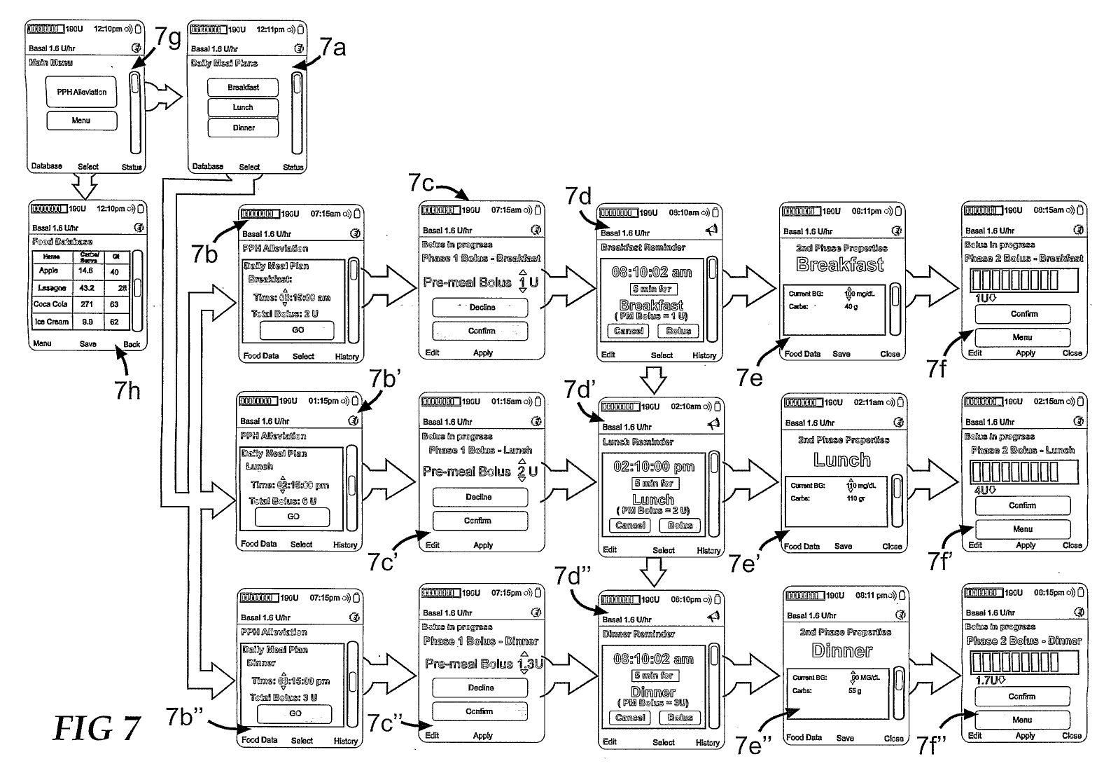

FIGS. 7a-h provides an example of a user interface for a PPH alleviating feature using navigation windows for data inputs according to some embodiments. FIGS. 7a, 7b, 7b′ and 7b″ illustrate examples of windows (also referred-to as “screens” and “displays”) for inputting a daily bolus plan. The bolus plan can comprise the number of meals and approximate bolus size and meal time (“time”) for each meal.

FIGS. 7c, 7c′ and 7c″ illustrate examples of windows for confirming delivery of the first phase bolus (e.g. 60 minutes before the contemplated meal time) according to some embodiments.

FIGS. 7d, 7d′ and 7d″ illustrate examples of windows for reminding the user to consume a meal (e.g. 5 minutes before the contemplated meal time) according to some embodiments. In some embodiments, the reminders can be visual, audible or vibrational. In some embodiments, the reminder can be provided at the time that corresponds to the type of the insulin used. For example, if the rapid-acting insulin (e.g. Lispro, Aspart, Glulisine) is used, then the reminder can be provided closer to the food intake time. If the regular insulin (e.g. NPH) is used, the reminder can be scheduled further from the food intake time.

In some embodiments, the reminder can also be provided at the time that corresponds to the GI of the contemplated intake. For example, the higher is the GI, the earlier the notice to the user is given.

In some embodiments, multiple reminders can be created to accommodate for multiple phases of bolus doses. For example, if the total insulin bolus is divided into a first phase bolus and a second phase bolus, a separate reminder can be created for each bolus phase. In some embodiments, a user can also be reminded about the beginning and/or an end of each phase.

FIGS. 7e, 7e′ and 7e″ illustrate examples of a window for inputting current blood glucose levels, and carbohydrate load of the intake for selecting the final total bolus size, immediately before the meal, according to some embodiments. The size of the second phase bolus can be adjusted according to the final total bolus size. FIGS. 7f, 7f and 7f′ illustrate examples of windows for confirming delivery of the second phase bolus (e.g. immediately before the contemplated meal time).

FIG. 7g illustrates an example of a main window of an PPH alleviating feature according to some embodiments. Additional windows can be accessible via the main window or other windows used by the PPH alleviating feature. For example, a food database window can be used providing data regarding different foods and their characteristics and/or content (e.g. carbohydrate load and glycemic index), as illustrated in FIG. 7h. The food database may also be accessed via other windows, such as the windows displayed in FIGS. 7a and 7b.

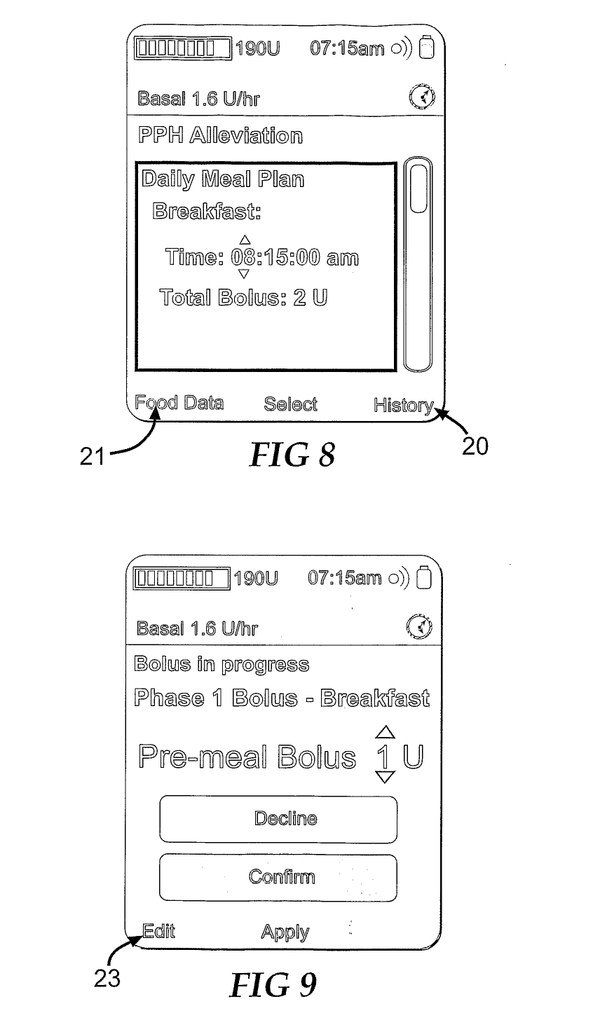

FIG. 8 illustrates a window for inputting a daily bolus plan according to some embodiments. In the given example, the user can input data regarding a planned breakfast, for example bolus size of 2 U and a meal time set to 08:15.

In some embodiments, the user may access a database associated with various food products via the window depicted in FIG. 8, for example, by pressing the “FoodData” soft key (21). The database may comprise information such as the carbohydrate load and the glycemic index (GI) of various foods. By pressing the “History” soft key (20), the user may access a window displaying information related to past occurrences and/or events such as previous doses administered in correspondence with a breakfast.

FIG. 9 illustrates in more detail a window for confirming the delivery of a first phase bolus according to some embodiments. In the given example, a user confirms a first phase bolus of 1 U at 07:15 which equal to 50% (for example) of the total bolus calculated to balance the breakfast planned for 08:15, as illustrated in FIG. 8. The user may change the dose or the time of delivery of the first phase bolus by pressing the “Edit” soft key (23). Otherwise the user may confirm the delivery of the first phase bolus or decline delivery. In some embodiments, other input means (e.g. buttons, switches, touch-screen, voice commands) may be employed instead of soft keys.

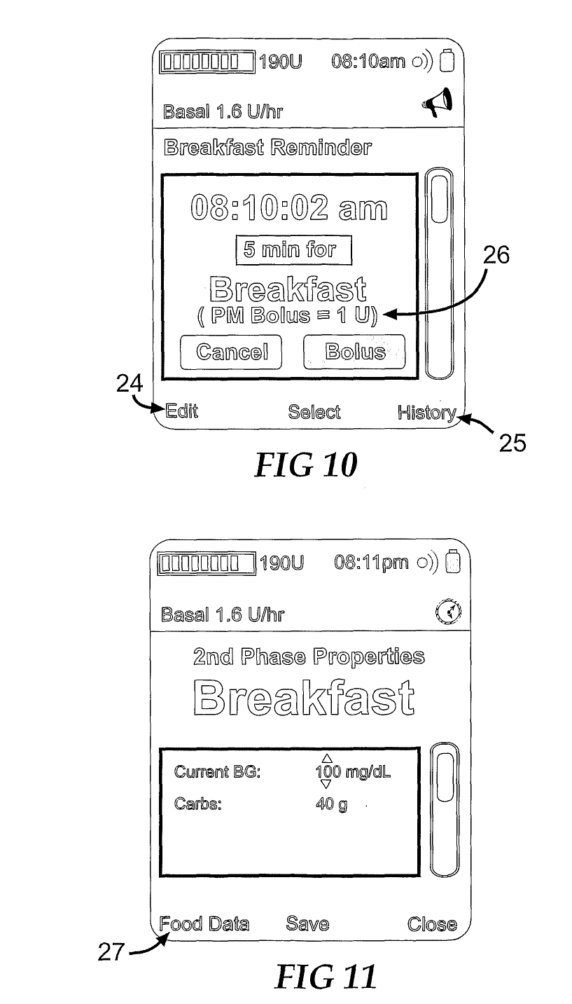

FIG. 10 illustrates in more detail a window that can be used for reminding the user to consume a meal (e.g. 5 minutes before the contemplated meal time), for example, according to some embodiments. In the given example, the user can be reminded at 08:10 to consume the breakfast planned for 08:15 as illustrated in FIG. 8. Information regarding the dose of the first phase bolus can also be displayed (26), e.g., 1 U in the given example.

In some embodiments, the user may enter/access a window for changing the dose calculated initially (e.g. 2 U) by pressing the “Edit” soft key (24). Such a window is illustrated in more detail in FIG. 10. For example, by pressing the “History” soft key (25), the user may enter/access a window displaying information such as previous breakfast doses.

FIG. 11 illustrates in more detail a window for inputting current blood glucose level, and carbohydrate load of the intake immediately before the meal, according to some embodiments. This information is required for selection of the final total bolus size as selected by a method for selection of the desired bolus dose, as described in co-owned, co-pending U.S. publication No. 20080234663, the disclosure previously having been incorporated by reference in its entirety. The user may also access a database associated with various foods via the window depicted in FIG. 11 by pressing the “FoodData” soft key (27), for example.

Various embodiments of the subject matter described herein may be realized in digital electronic circuitry, integrated circuitry, specially designed ASICs (application specific integrated circuits), computer hardware, firmware, software, and/or combinations thereof. These various embodiments may include embodiment in one or more computer programs that are executable and/or interpretable on a programmable system including at least one programmable processor, which may be special or general purpose, coupled to receive data and instructions from, and to transmit data and instructions to, a storage system, at least one input device, and at least one output device. In particular, some embodiments include specific “modules” which may be implemented as digital electronic circuitry, integrated circuitry, specially designed ASICs (application specific integrated circuits), computer hardware, firmware, software, and/or combinations thereof.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Some embodiments of the present disclosure preferably implement the PPH alleviation feature via software operated on a processor contained in a remote control device of an insulin dispensing system and/or a processor contained in a insulin dispensing device being party of an insulin dispensing system.

Any and all references to publications or other documents, including but not limited to, patents, patent applications, articles, webpages, books, etc., presented in the present application, are herein incorporated by reference in their entirety.

Although a few variations have been described in detail above, other modifications are possible. For example, the logic flow depicted in the accompanying figures and described herein do not require the particular order shown, or sequential order, to achieve desirable results. Other embodiments are possible, some of which, are within the scope of the following claims.

1-54. (canceled)

55. A method for alleviating postprandial hyperglycemia comprising:
providing a device which includes:
a first user interface for inputting a food intake time and a food intake type; and
a processor;
determining, by the processor, a total bolus dose of a drug corresponding to at least one of said food intake time and said food intake type and optionally to a glucose concentration level of a user;
dividing, by said processor, said total bolus dose into at least a first phase bolus dose and a second phase bolus dose;
scheduling delivery of each of said first phase bolus dose and said second phase bolus dose, wherein said first phase bolus dose is scheduled for delivery at a first delivery rate and at a first delivery time, and wherein said second phase bolus dose is scheduled for delivery at a second delivery rate and at a second delivery time.

56. The method of claim 55, wherein said food intake type corresponds to at least one of an amount of carbohydrates, glycemic index, fat content, and meal size.

57. The method of claim 55, wherein said first phase bolus dose is scheduled for delivery prior to said food intake time such that said first phase bolus dose ends substantially before or at about said food intake time.

58. The method of claim 55, wherein said second phase bolus dose is scheduled for delivery substantially after or at about said food intake time.

59. The method of claim 55, wherein said second phase bolus dose comprises one or more consecutive phases of bolus doses.

60. The method of claim 55, wherein at least one of said first phase bolus dose and said second phase bolus dose are scheduled for delivery according to pre-programmed bolus delivery rates and corresponding bolus delivery times.

61. The method of claim 55, further comprising adjusting at least one of said second phase bolus dose, said second delivery rate and said second delivery time.

62. The method of claim 55, further comprising decreasing a basal rate to a minimum rate for a period of time, said period of time associated with delivery of at least said first phase bolus dose.

63. The method of claim 55, further comprising cancelling said second phase bolus doses.

64. The method of claim 55, wherein said first delivery time is initiated about 10 to about 90 minutes before said food intake time.

65. The method of claim 55, further comprising determining a daily bolus plan, said daily bolus plan includes one or more total bolus doses input, the one or more total bolus doses corresponding to one or more food intake times and food intake types, each total bolus dose divided to at least first phase bolus dose and second phase bolus dose.

66. The method of claim 65, further comprising:
storing, in a memory, first phase bolus doses, including associated first delivery times and first delivery rates, and second phase bolus doses, including associated second delivery times and second delivery rates; and
retrieving, from said memory, information including previous deliveries of first phase bolus doses, previous first phase bolus delivery times, previous second phase bolus doses and previous second phase bolus delivery times;
wherein determining said daily bolus plan is based on said retrieved information.

67. The method of claim 55, wherein said first phase bolus dose constitutes about 10% to about 90% of said total bolus dose.

68. The method of claim 55, wherein at least one of said first phase bolus dose and said first delivery rate correspond to the glycemic index of said food intake.

69. The method of claim 55, further comprising notifying said user to consume said food intake and/or to administer any portion of said total bolus prior to or at about said food intake time.

70. The method of claim 69, wherein said notifying can be snoozed by said user.

71. The method of claim 69, wherein said drug is insulin and said notifying time corresponds to a type of insulin.

72. The method of claim 69, wherein said notifying time corresponds to said food intake time and/or to said food intake type.

73. The method of claim 55, further comprising administering said first phase bolus dose using said first delivery rate at said first delivery time to said user; and optionally, administering said second phase bolus dose using said second delivery rate to said user.

74. A device for alleviating postprandial hyperglycemia comprising:
a first user interface for inputting a food intake time and a food intake type;
a processor having instructions operating thereon to enable said system to:
determine a total bolus dose of a drug corresponding to at least one of said food intake time and said food intake type and optionally to a glucose concentration level of a user,
divide said total bolus dose into at least a first phase bolus dose and a second phase bolus dose; and
schedule delivery of each of said first phase bolus dose and said second phase bolus dose, wherein said first phase bolus dose is scheduled for delivery at a first delivery rate and at a first delivery time, and wherein said second phase bolus dose is scheduled for delivery at a second delivery rate and at a second delivery time.

75. A method for alleviating postprandial hyperglycemia comprising:
providing a device which includes:
a first user interface for inputting a food intake time and a food intake type; and
a processor;
determining, by the processor, a total bolus dose of a drug corresponding to at least one of said food intake time and said food intake type and optionally to a glucose concentration level of a user;
dividing, by said processor, said total bolus dose into at least a first phase bolus dose and a second phase bolus dose;
scheduling said first phase bolus dose at a first delivery rate and at a first delivery time prior to said food intake time, such that said first phase bolus dose is completed before said food intake time; and
scheduling said second phase bolus dose at a second delivery rate and at a second delivery time substantially at said food intake time.
